(19) United States
(12) Patent Application Publication
(10) Pub. No.: US 2025/0320398 A1
(43) Pub. Date: Oct. 16, 2025

(54) PELLETIZED SOLIDS FOR REVERSIBLY STORING AND RELEASING THERMOCHEMICAL ENERGY, AND RELATED COMPONENTS, SYSTEMS AND METHODS

(71) Applicant: Cache Energy Storage Inc., Champaign, IL (US)

(72) Inventors: Arpit Dwivedi, Champaign, IL (US); Lakshmi Amulya Nimmagadda, Champaign, IL (US); Paul Ginsberg, Champaign, IL (US); Fotios Vakakis, Champaign, IL (US)

(21) Appl. No.: 19/176,119

(22) Filed: Apr. 10, 2025

Related U.S. Application Data
(60) Provisional application No. 63/632,282, filed on Apr. 10, 2024.

(51) Int. Cl. C09K 5/16; F28D 20/00

(52) U.S. Cl. CPC C09K 5/16; F28D 20/003; F28D 2020/0017

(57) ABSTRACT

A multiphase pellet comprises a calcium-based material in combination with an aluminum-containing binder or a silicon-containing binder, or both. The multiphase pellet can undergo more than about 300 standard cycles of charging and discharging. The calcium-based material can include one or more of lime, limestone, plaster-of-paris, calcium oxide and calcium carbonate. The binder can include one or more of Portland cement, alumina, aluminum hydroxide, an aluminosilicate, calcium aluminate cement, bauxite, and kaolin. The multiphase pellet can be used to store and to release thermochemical energy. For example, the multiphase pellet can be charged by heating it, e.g., at a temperature of at least about 350° C., to store energy. The multiphase pellet can be discharged using water, steam, or humidified air, or a combination thereof, to cause the pellets to release heat.

### FIELD

This application and the subject matter disclosed herein (collectively referred to as the “disclosure”), generally concern components, systems and methods for improved gas-solid reaction cycling. More particularly, but not exclusively, this disclosure pertains to rechargeable, pelletized fuels that possess high and lasting energy density, mechanical strength, and related components, systems and methods.

### BACKGROUND INFORMATION

When heated, materials can store thermal energy through changes in sensible heat (e.g., a change in temperature with the addition or dissipation of heat), latent heat (e.g., a change in phase with the addition or dissipation of heat), or chemistry (e.g., a change in composition with the addition or dissipation of heat). Of these three types of thermal-energy storage, thermochemical energy storage (TCES) can provide high-energy density and long-term storage with a comparatively small irreversible energy loss.

Many materials can decompose into constituent components when heated. For example, slaked lime Ca(OH)₂ can decompose to quick lime (CaO) and water (H₂O) when heated and can emit heat when re-hydrated (i.e., Ca(OH)₂ heat⇄CaO+H₂O) (sometimes referred to in the art as the “CaO/Ca(OH)₂ system”). The high heat capacity and decomposition temperature of the CaO/Ca(OH)₂ system makes it a good candidate for TCES applications. The quick lime and/or slaked lime are relatively inexpensive, they provide a relatively high energy density (e.g., about 500 (W·h)/kg), the dehydration/re-hydration reaction is highly reversible, and reaction temperatures of greater than about 550° C. can satisfy about 75% U.S. industrial process heating requirements, while also reducing dependence on nonrenewable energy sources. Additionally, these temperatures are high enough to drive efficient heat-to-power conversion cycles for electricity generation. However, the raw materials are difficult to work with since powder forms tend to agglomerate, and such agglomeration and sintering can reduce the number of dehydration/re-hydration cycles that a given quantity of material can undergo without degrading available energy density.

### SUMMARY

Gas-solid reactions have many applications, e.g., catalysis, carbon storage and energy storage, among many others. Disclosed principles pertain to one or more solid reactants combined with one or more inert or reactive binders into a pelletized form to allow a gaseous or liquid reactant sufficient access the one or more solid reactants (and reactive binder(s)) to permit a gas-solid reaction to occur. In some embodiments, the pelletized material can undergo many cycles of gas-solid reaction by virtue of the strength of individual pellets and the physical size of the pellets, which can permit a gas or a liquid reactant to penetrate or migrate to an interior of the pellet without significantly damaging or breaking down the pellet. In some disclosed embodiments, for example, powdered Ca(OH)₂ is combined with a cementitious binder and pelletized to provide pelletized material suitable for reversibly storing and discharging thermochemical energy.

In a broad sense, thermochemical storage systems involve storing and generating energy using chemical reactions. Charging (or energy storage) typically involves heating a hydrated or carbonated or oxidized or hydrogenated material (e.g., metal hydroxide, metal carbonate, metal oxide or metal hydride) to a high temperature, e.g., upwards of 120° C. to dehydrate or decarbonate or reduce or dehydrogenate, respectively, the material and form a dehydrated or a decarbonated or a reduced or a dehydrogenated material (e.g., metal oxide). Discharge (or energy release) involves initiating and maintaining a reaction by, in part, supplying a suitable reactant to the respective dehydrated or decarbonated or reduced or dehydrogenated material, such as, for example, supplying gaseous water, i.e., water vapor in form of steam or humidified air, to hydrate the dehydrated material, or supplying gaseous CO₂ to carbonate the decarbonated material, or supplying O₂ to oxidize the reduced material (e.g., metal oxide) or supplying gaseous H₂ to hydrogenate the dehydrogenated material (e.g., metal hydride) and reform the hydrated/carbonated/oxidized/hydrogenated material (e.g., metal hydroxide, metal carbonate or metal oxide or metal hydride).

An exemplary charging process can involve heating discharged material to a high temperature, e.g., using an available energy source, such as, for example, solar energy (e.g., directed or concentrated solar energy, or electricity generated using photovoltaics), wind energy (e.g., electricity generated using wind turbines), hydroelectric energy, combustion, e.g., combustion of organic material, petroleum-based fuel or natural gas (whether by heating directly by heating from electricity generated from a combustion-driven generator). Such heating can release water vapor or CO₂ or O₂ or H₂ depending on the discharge material used. In some such embodiments, heating releases water molecules from a dehydratable material in the form of water vapor. The water vapor released can be used in multiple ways. For example, the water vapor can be condensed and stored as hot water in an insulated storage tank. Alternatively, it can be sent to a heat exchanger to provide heat to another heat-transfer fluid. As yet another alternative, the water vapor can be recirculated to supply necessary moisture for the discharge reaction.

A discharge process can involve passing one or more fluids, such as, for example, water in liquid or vapor form or CO₂ or O₂ or H₂ in gaseous form through the reactor to discharge a charged material compatible with the fluid. For example, water vapor can be used to hydrate a dehydrated material so as to release energy from the hydrated material. The final output from the reactor during such a discharge process in this embodiment is heated air at temperatures above 200° C. The heated air can be sent to a heat exchanger to utilize the heat released in the respective application. The same reactor can be used to perform both charging and discharging. It will be appreciated that less than 100% of the fluid may be consumed as the mixture of the fluid and air passes through the reactor, and thus the “heated air” noted above may include a mixture having a minor portion of the fluid reactant present.

In some respects, concepts disclosed herein generally concern pelletized solids for reversibly storing and releasing thermochemical energy. Some disclosed concepts pertain to systems, methods, and components to improve the number of charge/discharge cycles that pelletized material can undergo. As but one example, some disclosed pellets result from combining a selected binder with a powdered reactant to achieve a suitable mechanical strength within the pellet to inhibit or prevent mechanical failure of the pellet, while also maintaining a suitable ability to hydrate and dehydrate the reactant.

To reduce agglomeration of powder particles, disclosed embodiments use or form pellets from powdered raw material.

However, breakage of solid particles or pellets within a chemical reactor, e.g., due to turbulence and vigorous mixing, presents a practical challenge for wide, industrial-scale applications. Particle attrition/fragmentation phenomena cause elutriation-escape of fine particle size material from the bed which results in the loss of valuable material. It also changes the particle size distribution of the material inside the bed which influences the bed fluid-dynamics, heat and mass transfer and reaction rates. Very fine particles produced as a result of attrition or fragmentation also tend to agglomerate, making the solid reactant difficult to move through the reactor.

Disclosed, pelletized forms of the solid reactant maintain particle sizes preventing or inhibiting loss of fine particles. Moreover, disclosed pellets maintain high reactivity by maintaining a porous structure for the reactant fluid to diffuse in, through and out of the pellets.

Disclosed pelletization techniques use binders, along with active material to achieve high strength pellets. However, adding binder according to prior techniques not only reduced the amount of active material per unit weight of pellets but also significantly reduced its reactivity with cycling. Alternatively, such prior binders provided only limited strength, resulting in low-cycle life that has been inadequate for industrial scale applications due to pellet breakage. Such breakage also resulted in material loss due to the generation of fine particles which required the addition of replacement material.

A binder, such as, for example, Portland cement, calcium aluminate cement (CAC), or kaolin, bauxite or a combination thereof, can be used to ensure that powdered particles remain aggregated together in pellets. Suitable processing conditions to obtain well-performing pellets during thermochemical cycling has not previously been well established. This is due to the huge variability of the binder phases during cycling which are responsible for the cycling strength in the pellets. Another reason is the degradation of the strength of the pellets with the number of cycles. The strength of the pellets depends on the hydration of the binder. Hydration of CAC can lead to the formation of metastable or stable hydrates based on the reaction conditions.

Pellet strength generally deteriorates with an increasing number of cycles, e.g., due to volume changes as the pellet charges and discharges. Maintaining or regaining energy density and mechanical strength has been found to be important for a suitable material to be used in energy storage. This disclosure describes, among other things, suitable procedures to pelletize a reactant to ensure a desired number of charge/discharge cycles, in part by ensuring a strong binder network within the pellet.

Disclosed pelletized solids include, by way of example and not limitation, lime-based pellets that can be used under severe conditions to store and discharge energy, e.g., thermochemical energy. Some embodiments of disclosed pelletized solids are rechargeable over many cycles of energy storage and discharge. Some embodiments of disclosed pelletized solids are durable and mechanically strong, inhibiting particle attrition or fragmentation during their useful life and improving cycle life over prior approaches. Also disclosed are process parameters and methods for producing pellets to achieve one or more desired qualities. Further, one or more approaches for regenerating degraded pellets, e.g., after they have lost a measure of mechanical strength or chemical reactivity during their useful life are disclosed. Some disclosed pellet embodiments can operate at multiple reaction temperatures and can produce energy at different temperatures depending on the application needs. Approaches for producing pellets operable at a selected reaction temperature also are described.

According to a first aspect, a multiphase pellet includes a calcium-based material in combination with an aluminum-containing binder or a silicon-containing binder, or both. The multiphase pellet can undergo more than about 100 standard cycles of charging and discharging, e.g., to store and to release, respectively, energy. In some embodiments, the multiphase pellet can be formulated to store and to release thermochemical energy through charging and discharging processes, respectively. In some embodiments, such a multiphase pellet has an accessible energy storage capacity between about 700 kJ/kg and about 1100 kJ/kg. In other embodiments, the accessible energy storage capacity is between about 800 kJ/kg and about 1650 kJ/kg.

The calcium-based material can include one or more of lime, limestone, plaster-of-paris, calcium oxide and calcium carbonate.

The binder can include one or more of Portland cement, alumina, aluminum hydroxide, an aluminosilicate, calcium aluminate cement, bauxite, and kaolin.

In some embodiment, the pellet gains at least 95% of a theoretical percentage weight gain of the pellet during hydration after undergoing more than about 100 standard cycles of charging and discharging.

The multiphase pellet can have a mean characteristic dimension equal to or less than about 6 mm. In some embodiments, the multiphase pellet has a mean characteristic dimension equal to or greater than about 1 mm.

In some embodiments, the multiphase pellet can undergo more than about 1,000 standard cycles of charging and discharging.

The weight percentage of binder can be at least about 5%.

A complex hydrate phase can include C3AH6 and can dehydrate at temperatures between about 330° C. and 350° C., forming mayenite as the binder in the pellet's dehydrated state. In some embodiments, the mayenite binder can hydrate to C3AH6 on subsequent hydration of the multiphase pellet.

The aluminum-containing binder, when hydrated in the presence of CaO, can form C3AH6 as a complex hydrate phase.

According to another aspect, a method of storing and releasing thermochemical energy with a pelletized material comprising a calcium-based material in combination with an aluminum-containing binder or a silicon-containing binder, or both, is disclosed. The method includes charging the pelletized material by heating it at a temperature of at least about 350° C. and discharging the pelletized material with water, steam, or humidified air, or a combination thereof, to cause the pellets to release heat. In other methods, the pelletized material is heated at a temperature between about 300° C. and about 500° C., such as, for example, between about 400° C. and about 450° C.

An average pellet size of the pelletized material can remain above about 0.8 mm after about 100 cycles of charging and discharging the pelletized material. In some embodiments, the average pellet size of the pelletized material remains above about 0.8 mm after about 1,000 cycles of charging and discharging the pelletized material.

The calcium-based material can include one or more of lime, limestone, plaster-of-paris, calcium oxide and calcium carbonate.

The binder can include one or more of Portland cement, alumina, aluminum hydroxide, an aluminosilicate, calcium aluminate cement, bauxite, and kaolin.

In some embodiments, the pelletized material gains at least 95% of a theoretical percentage weight gain of the pelletized material during discharge after undergoing more than about 100 standard cycles of charging and discharging.

The pelletized material can have a mean characteristic dimension equal to or less than about 6 mm. In some embodiments, the pelletized material has a mean characteristic dimension equal to or greater than about 1 mm.

The pelletized material can include C3AH6 after the act of hydrating the pelletized material. The pelletized material can include mayenite after the act of dehydrating the pelletized material. In some embodiments, the mayenite binder hydrates to C3AH6 on subsequent hydration of the pelletized material.

Some disclosed methods also include regenerating the pelletized material. The act of regenerating the pelletized material can include crushing the pellets into fine powder having a particle size less than about 50 μm. The act of regenerating the pelletized material can further include pelletizing the fine powder into a pelletized form having a mean characteristic dimension equal to or greater than about 1 mm. For example, the pelletized form can have a mean characteristic dimension equal to or less than about 6 mm.

The foregoing and other features and advantages will become more apparent from the following detailed description, which proceeds with reference to the accompanying drawings.

### BRIEF DESCRIPTION OF THE DRAWINGS

Referring to the drawings, wherein like numerals refer to like parts throughout the several views and this specification, aspects of presently disclosed principles are illustrated by way of example, and not by way of limitation.

FIG. 1 schematically illustrates a manufacturing process for pelletizing an embodiment of a thermochemical energy storage medium.

FIG. 2 depicts a photograph of a plurality of a pelletized thermochemical energy storage medium produced using a process as in FIG. 1 and suitable for being used for storing and releasing energy as described herein.

### DETAILED DESCRIPTION

The following describes various principles related to pelletized solids suitable for gas- solid reactions, such as, for example, catalysis, carbon capture and/or energy storage. For example, some disclosed principles pertain to pelletized solids for reversibly storing and releasing thermochemical energy, together with related components, systems and methods. For example, certain aspects of disclosed principles pertain to such pelletized solids and other aspects pertain to underlying processes, devices and systems for making and using such solids to store and release thermochemical energy. That said, descriptions herein of specific apparatus configurations and combinations of method acts are but particular examples of contemplated systems chosen as being convenient illustrative examples of disclosed principles. One or more of the disclosed principles can be incorporated in various other systems to achieve any of a variety of corresponding system characteristics.

Thus, systems having attributes that are different from those specific examples discussed herein can embody one or more presently disclosed principles and can be used in applications not described herein in detail. Accordingly, such alternative embodiments also fall within the scope of this disclosure.

### I. Overview

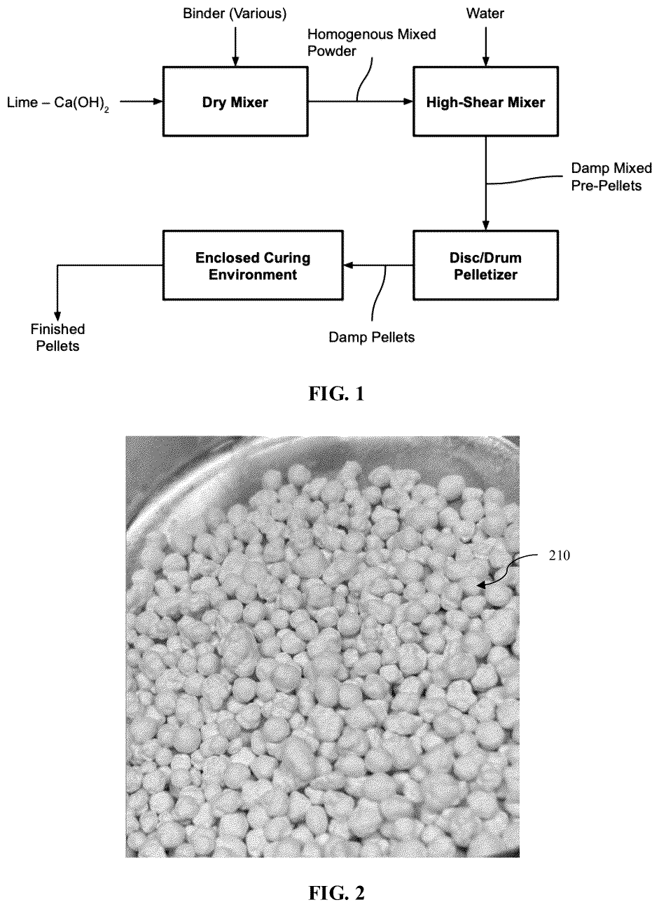

As shown in FIG. 1, a pelletized material can be produced with lime and a selected binder material, which upon processing, creates a strong pellet (e.g., pellet 210 in FIG. 2) that can be used in a reaction with fluid at elevated temperatures. The fluid can be liquid, gas, or a mixture of both. Such pellets can be used in a thermochemical storage system, such as, for example, a thermochemical system based on the hydration and dehydration of CaO and Ca(OH)₂. As noted, powdered or pelletized CaO/Ca(OH)₂, alone, has little mechanical strength and tends to agglomerate upon reacting with a fluid. However, adding a pulverized binder with the pulverized CaO/Ca(OH)₂ can produce pellets having a desirable size, also having a suitable strength to inhibit or prevent material attrition/fragmentation during use.

In some embodiments, raw material for the pellets can come from a combination of limestone and an inorganic binder. This material can be used at high temperatures as may be suitable for a desired reaction. For example, mixing lime with a binder material such as hydraulic cement and heating the mixture to a high temperature, e.g., above about 350° C., can produce a multiphase compound in the pellet. Such a multiphase compound can contribute to an improved internal mechanical strength of the pellet, as well as to a measure of energy density of the pellet. Generally speaking, the strength and the energy density of a given pellet depend on the composition of the pellet, e.g., a relative percentage (e.g., by weight) of individual phases of material present in the pellet. In addition to phase proportions, pellet performance also depends on the constituent materials in the pellet, e.g., the type of the binder added, as well as the conditions under which the combination of constituent materials were processed. Such conditions include, for example, how the raw materials are mixed together (e.g., mixed as dry powders, mixed as a slurry with liquid added) and how thoroughly, the pelletization process, and the conditions (e.g., temperature, pressure, and duration) under which the pellets are cured. Good results have been obtained with aluminum containing binders such as, for example, calcium aluminate cement and alumina/aluminum hydroxide under various selected percentage compositions. Other compositions of binders composed of multiple phases, for example, kaolin containing both alumina and silica, have been used, resulting in strong pellets with multiple reactive phases present.

Disclosed pellets can be produced on a large scale. For example, a disc pelletizer operating under suitable conditions (e.g., speed of rotation, angle of rotation and duration of operation) can be used for large-scale pelletization of disclosed materials. FIG. 2 shows a working embodiment of disclosed pellets suitable for storing and discharging thermochemical energy over many cycles that were produced using a disc pelletizer. Large scale production of pelletized material suitable for storing and discharging thermochemical energy over many cycles can alternatively be produced using a variety of other pelletizing procedures, such as, for example, using an extrusion process. Pellets produced using extrusion processes can have a cross-sectional form corresponding to the shape of die through which the material was extruded, e.g., a round aperture in the die can lead to a generally cylindrically shaped pellet.

Specific combinations of parameters can be selected to reduce, minimize, or even eliminate the generation of dust (e.g., particles having a characteristic dimension of less than about 0.8 mm), fragmentation of pellets, or both, during a selected pelletization process. As FIG. 1 indicates, powdered forms of the binder and lime can be combined in a dry mixer to produce a homogeneous mixed powder of binder and lime. Water can be added to the homogeneous mixed powder in a high-shear mixer, for example, before the now damp material is pelletized into a suitable shape and size. For example, a selected pelletization process using a disc or a drum pelletizer can be controlled so as to produce pellets having a mean characteristic dimension equal to or less than about 6 mm, e.g., between about 2 mm and about 6 mm, such as, for example, between about 2.5 mm and about 5.5 mm, e.g., about 4.5 mm to about 5 mm. Disclosed pellets can gain internal mechanical strength as the binder added to the pellet mixture cures. Referring still to FIG. 1, after being pelletized in the disc or drum pelletizer, the damp pellets can be cured, e.g., in an enclosed curing environment, to produce finished and usable, and high-strength, pellets from the damp pellets.

However, such strength can often be lost for many binders when they are heated to above about 450° C. However, with some disclosed binders, such high temperatures can transform a hydrated binder phase into another, complex phase that provides internal mechanical strength to the pellet at such an elevated temperature. In some embodiments, pellets may also be able to gain significant mechanical strength and resistance to cycling through sintering at an elevated temperature for a length of time, for example at 900° C. for four hours. Moreover, the effectiveness of some disclosed pellets is independent of the source of raw material, allowing such pellets to be made from a wide variety of lime and binders without losing significant mechanical strength or chemical reactivity.

### II. Complex-Phase Pellet Embodiments

Pellets formed of, for example, lime and calcium aluminate cement, when treated under suitable conditions, can form a complex phase in the pellet. Such a complex phase can form a network that provides mechanical strength to the pellet. The creation of such a complex phase can also create pores, or interstitial voids, within and throughout the pellet. Such pores can provide pathways for a fluid to penetrate into and react with the material of which the pellet is formed. Most any material containing aluminum in its elemental form or in a combined form, such as, for example, alumina, aluminosilicates, or aluminum hydroxide, can be combined with CaO to form such a complex phase.

In some embodiments, pellets can be prepared by dry blending selected proportions of powdered Ca(OH)₂ and one or more powdered, cementitious binders in a cement mixer. For example, a suitable cementitious binder is calcium aluminate cement (CAC) with weight composition of monocalcium aluminate (CaAl₂O₄), referred to herein as “CA,” and monocalcium dialuminate (CaO·2Al₂O₃), referred to herein as “CA₂,” varying between about 30:70 (e.g., between about 25:75 and about 35:65) to about 60:40 (e.g., between about 35:65 and about 45:55). Alumina (Al₂O₃) is another suitable, disclosed binder. Water can be added in small amounts to such a dry blended mixture until powder is able to agglomerate easily.

Such a wet mixture can be added to a disc pelletizer. As the disc revolves, a controlled amount of water can be added as a fine spray and the wet mixture can begin rolling into approximately spherical pellets which can be sieved through a mesh to obtain pellets of a desired size, e.g., between about 2 mm in diameter to about 6 mm diameter. Larger pellets can be crushed and returned to the pelletizer. Undersized pellets can be returned to the disc pelletizer with or without crushing. In this way batches of pellets of desired composition and size(s) can be produced.

Processing conditions (e.g., time, temperature, volume and rate of fine water spray, disc speed, etc.) can be varied to obtain pellets having desired characteristics, e.g., cycle life as indicated by reactivity variation with number of charge/discharge cycles, or long-term internal mechanical strength, as evidenced by, for example, pellet-size variation with number of charge/discharge cycles. For example, combinations of processing conditions can be varied and the resulting pellets' cycle life or long-term internal mechanical strength can be determined for each combination. Suitable cycle life or long-term internal mechanical strength can be selected according to desired industrial processes, and thus corresponding combinations of processing conditions can be identified.

In some embodiments, a weight fraction of binder added to lime is between about 0.1 and about 0.4. The pellets can be used in a cycling system where they undergo continuous hydration (which emits heat), followed by dehydration (which absorbs heat). Performance during such a cycling process can provide details on the pellet reactivity and strength. In general, the strength of the pellets depends on the composition of the binder material. Such pellets can be used in a thermochemical energy storage system involving hydration of CaO using either steam or water or a mixture of water vapor/steam and air (a discharging process), and dehydration of Ca(OH)₂ (a charging process).

### III. Exemplary Pellet Characteristics

Some disclosed pellets exhibit the following characteristics. For example, in some embodiments, the percentage weight gain following hydration of CaO is at least 95% of the theoretical percentage weight gain after 1000 standard cycles of charging and discharging the pellets. In some disclosed embodiments, a standard cycle of charging and discharging may be defined as dehydrating pellets (e.g., in air) by heating them to temperatures above about 350 C (charging). Subsequently, the charged pellets can be discharged by introducing moisture in some form, for example water, steam or humidified air, to cause the pellets to emit heat. Such dehydration followed by hydration completes one cycle of charging and discharging the pellets. In some embodiments, Pellets may be considered fully charged or discharged when they have achieved at least 95% of the total theoretical weight change from dehydration or hydration, respectively. The duration for dehydrating or hydrating the pellets may depend on several factors, among them being temperature for charging (dehydration) and moisture content and temperature for discharging (hydration), respectively. Some pellet embodiments can also react with carbon dioxide (CO₂) present during charging or discharging under some temperature and humidity conditions. Such reactions with carbon dioxide can form calcium carbonate (CaCO₃) or other complex phases. Such pellets that contain CaCO₃ along with CaO/Ca(OH)₂ can provide an increase in the discharging reaction temperature, as well as the energy density. In some disclosed embodiments, an average pellet size can remain above 0.8 mm after 1,000 standard cycles.

Pellets produced using a pelletization process as described can be cured under high humidity conditions, e.g., between about 75% and about 99% relative humidity. Curing can be done at a selected temperature between, e.g., room temperature and about 90° C. The curing temperature (and duration) selected can determine the initial strength of the pellet, as well as the microstructure in the pellet. Alternatively, autoclaving at temperatures up-to 110° C. in presence of water can also provide strength to fresh pellets.

In a working CAC embodiment, curing pellets for about 48 hours at about 60° C. or at room temperature for about 5 days yielded sufficient cycling life and mechanical strength. In another working embodiment based on Alumina, curing pellets for about 24 hours at about 60° C. yielded sufficient cycling life and mechanical strength.

These working embodiments of pellets were tested in hydration and dehydration for potential use in a system for storing thermochemical energy. As the pellets were heated to temperatures above 450° C. to decompose Ca(OH)₂, the hydrates of alumina/CAC, CaO and Al₂O₃ in the pellet combine to form a complex calcium aluminate phase. The pellets became multiphase (e.g., containing this complex binder and CaO) in their dehydrated state. The mechanical strength of the pellets was determined by tumbling the pellets in a tumbler after every 30 cycles and observing the breakage of the pellets. The walls of the tumbler were lined with a metal sheet and a baffle to mechanically agitate the pellets and reflect conditions representative of a reactor. ,Pellets under such tests can break from collisions with other pellets, as well as with the walls of the tumbler.

XRD analysis of such samples detected the formation of mayenite whose chemical formula is Ca₁₂Al₁₄O₃₃ (C12A7) as the composite binder in a pellet containing calcium aluminate cement as the binder. The cementitious binder can be any aluminum or silica containing binders such as, for example, calcium aluminate cement, e.g., with a ratio of CaO to Al₂O₃ varying from about 3:7 (e.g., from about 2.5:6.5 to about 3.5:7.5) to about 1:1 (e.g., between about 0.8:1.02 and about 1.02:0.8), and pure alumina (Al₂O₃) or aluminum hydroxide (Al(OH)₃). Pellet strength in this embodiment is surmised to come, in part, from the formation of the complex binder (C₁₂A₇) when the pellets are heated to temperatures above about 350° C. The amount of C₁₂A₇ formed can depend, in part, on the amount of binder added, which in turn can affect the mechanical strength of the pellets. Testing of working pellet embodiments demonstrated that the weight percentage of C₁₂A₇ can vary between about 15% to about 90% to obtain pellets of suitable mechanical strength and chemical reactivity. The amount of complex binder and CaO in the pellet can be varied depending on the desired energy density of the pellet as per the application. In particular embodiments, the weight percentages of CAC can vary from about 10% to about 60% and alumina can vary from about 10% to about 40% to produce a suitable amount of complex binder with desirable energy density for energy storage applications. This feature can help with releasing energy stored at different temperatures depending on the application. A greater amount of binder can yield higher mechanical strength, and those pellets can be cycled for more cycles. Nevertheless, even for pellets having a binder weight percentage of about 10%, the pellets can be cycled up to about 100 cycles without any major loss in mechanical strength or chemical reactivity.

As noted, pellets were rolled in a disc pelletizer to mimic mass production of the pellets on a large scale for a practical application. These pellets, when not mixed with enough water prior to rolling, can generate powder, which in turn can lead to powder agglomeration and loss in chemical reactivity among the pelletized material. Wet mixing of the powders by adding sufficient amounts of water (e.g., about 1:1 by weight of the binder added) helped with densifying the pellets and reducing loose powders on the pellets. Pellets from the disc pelletizer are sieved to remove any loose powders.

As used herein, “curing” refers to keeping the freshly made pellets which contain excess water under high humidity conditions to allow for the added binder material to form hydrates that provide initial mechanical strength to the pellets. Temperature and time are two significant control variables that can affect the type of hydrate, the microstructure, and the size of the hydrate crystals in such pellets. In the case of CAC, hydration can lead to formation of metastable hydrates CAH₁₀ and C₂AH₈, which when given enough time, form stable hydrate C₃AH₆ which is relatively denser compared to other phases. However, in the presence of a basic environment, conversion of metastable hydrates to stable hydrates happens quickly. From observations, formation of stable hydrate phase, C₃AH₆can be desirable for the pellets to develop sufficient mechanical strength. Formation of the stable hydrate phase can be achieved by curing the pellets, e.g., preferably at about 60° C. for a duration of between about 24 hours and about 48 hours or at room temperature for a duration between 5 days and 7 days. In the case of any Al₂O₃/Al(OH)₃ containing binder, calcium present in the pellet reacts with aluminum to form the stable hydrate, C₃AH₆. The duration and temperature of curing depends on the type of binder added. When the binder is Al₂O₃, the pellets cured at about 60° C. for a duration of about 24 hours show better mechanical and cycling strength. Pellets which are held for longer periods of time at higher temperatures undergo further crystal growth at least up to about 80° C. Al(OH)₃-based pellets may not require curing, as the binder is already in its hydrated form. A distribution of Al(OH)₃ can suffice such that the pellets with Al(OH)₃ as binder with no curing can perform similar to pellets made with Al₂O₃ as the binder with about 24 hours of curing. Pellets made from CAC and Al₂O₃ that are cured for less than the durations indicated above had relatively lower mechanical strength and cycling strength.

Nevertheless, pellets that appear to have lost reactivity can be regenerated to their full capacity by crushing (e.g., pulverizing) the pellets and re-pelletizing the resulting powder. For example, used pellets can be crushed into a fine powder to destroy the existing pellets. The fine powder can then be re-processed using a technique as indicated above to form pellets. Such regenerated pellets can have similar mechanical strength and reactivity as the pellets that were made with fresh, unused materials. Crushing and re-pelletization permitted some embodiments to regain the percentage weight gain to its full theoretical value.

In some embodiments, a thermochemical energy storage system can include a chemical reactor with a fixed bed, a fluidized bed, a moving bed, or a combination thereof. In such systems, a measure of crushing strength can be used to assess mechanical strength of the pellets. Another suitable metric is the tumbling strength, which corresponds to breakage of material and particle distribution. Tumbling strength can be useful in assessing suitability of pellets for use in the reactor, as the pellets tend to bump against each other and the reactor walls. Crushing strength can be measured in units of N/mm, and tumbling strength can be measured in units of particle-size distribution, e.g., in the ranges of, for example, greater than 1.6 mm, between about 1.6 and about 0.8 mm, and less than about 0.8 mm. Any particle less than about 0.8 mm can be considered dust (or powder). Typically, particles less than about 0.8 mm are not used in the reactor and instead are removed. Accordingly, a relatively lower weight of particles smaller than 0.8 mm after tumbling corresponds to a relatively higher tumbling strength.

In practice, pellets can be tumbled at regular intervals, e.g., after about 30 cycles. Such tumbling may be performed on pellets in their dehydrated/charged state. Mechanical strength of pellets in their hydrated/discharged state will tend to be greater than their strength in a dehydrated, charged state. Based on observations of particle-size distribution over hundreds of cycles, pellets with relatively higher binder content resulted in relatively less dust (e.g., particles smaller than about 0.8 mm) generation. Further, observed weights of such fine particles tended to increase with the number of cycles, and saturated at about 300 cycles in some embodiments. Stated differently, after about 300 cycles, those embodiments of pellets did not tend to break apart further as the number of cycles increased. In other embodiments, the fine particles tend to saturate at about 200 cycles and in other embodiments at about 100 cycles. As noted above, crushing and repelletization can be used to form pellets from such fine particles that cannot be used in a thermochemical reactor, which reduces material loss. And, as noted, such remade pellets exhibit similar mechanical strength and chemical reactivity as the initially formed pellets.

Another significant aspect of this disclosure pertains to the contribution of binder towards energy density. The binder's contribution to the energy density of the pellet can be considered a useful metric for thermochemical storage applications. In some embodiments of disclosed pellets, binder hydration contributes to about one-half of the total energy density observed for the pellet. And, such energy can be released during the hydration process. Stated differently, to extract a high level of performance from disclosed pellets, hydrating both the binder and CaO can be desirable. Experiments demonstrated that hydration of binder benefited from high pH conditions which can arise through the formation of Ca(OH)₂ during hydration. For example, the formation of Ca(OH)₂ during hydration can result in a pH approaching and even greater than 12. In some embodiments, binder contributes to the energy density and weight gain during hydration only in the presence of CaO/Ca(OH)₂. Another notable aspect of some disclosed pellets is the difference in the dehydration temperatures of the composite binder and Ca(OH)₂. The composite binder can dehydrate at lower temperatures, e.g., below about 350° C. and Ca(OH)₂ dehydrates at about 550° C. Such a difference in reaction temperature can allow disclosed thermochemical energy storage system to be operated in different modes, e.g., depending on the application.

As used herein, variations of the term “CxAyHz” refers to a compound in which one mole of said compound contains x moles of CaO, y moles of Al2O3 and z holes of H2O. In some working embodiments, a pelletized energy storage medium can store and release thermochemical energy through charging and discharging processes, respectively, as described above. In some embodiments, the storage medium stores between about 800 kJ/kg and about 1650 kJ/kg (e.g., a reaction enthalpy per weight of discharged material, omitting sensible heating), e.g., between about 700 kJ/kg and about 1700 kJ/kg, such as, for example, between about 900 kJ/kg and about 1500 kJ/kg, or between about 1,000 kJ/kg and about 1400, or between about 1,100 and about 1,300 kJ/kg or between about 1,150 kJ/kg and about 1,250 kJ/kg, e.g., about 1,200 kJ/kg. Sensible heating, in such an embodiment, can contribute between about 200 kJ/kg and about 480 kJ/kg (e.g., sensible heat per weight of discharge material), e.g., between about 150 kJ/kg and about 500 kJ/kg, or between about 225 kJ/kg and about 450 kJ/kg, or between about 250 kJ/kg and about 400 kJ/kg, or between about 300 kJ/kg and about 350 kJ/kg.

### VII. Other Embodiments

The examples described above generally concern apparatus, methods, and related systems to make and use pellets comprising lime and a selected ceramic binder in a thermochemical storage system. For example, disclosed pellets can be dehydrated by adding energy in the form of heat derived from renewable natural resources, solar, hydroelectric, and/or wind energy. Further, such dehydrated forms of disclosed pellets (which store thermal energy that can be released by hydrating with water, water vapor/steam or water vapor and air) can be stored for long durations, and/or transported over large distances. And, dehydrated forms of pellets can be hydrated to release energy in the form of heat, which in turn can be used to power industrial processes, provide heat to any of a variety of residential, commercial, or industrial installations, and/or to generate electricity on a small, large or community scale. In some embodiments, existing coal-fired electric plants can be retrofitted to use disclosed pellets as a heat source to generate steam, which in turn is used to power turbines that generate electricity. After being hydrated, such pellets can be dehydrated using energy obtained from solar, wind, hydroelectric or another form of renewable resource.

Nonetheless, the previous description is provided to enable a person skilled in the art to make or use the disclosed principles. Embodiments other than those described above in detail are contemplated based on the principles disclosed herein, together with any attendant changes in configurations of the respective apparatus or changes in order of method acts described herein, without departing from the spirit or scope of this disclosure. Various modifications to the examples described herein will be readily apparent to those skilled in the art.

Directions and other relative references (e.g., up, down, top, bottom, left, right, rearward, forward, etc.) may be used to facilitate discussion of the drawings and principles herein, but are not intended to be limiting. For example, certain terms may be used such as “up,” “down,”, “upper,” “lower,” “horizontal,” “vertical,” “left,” “right,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” surface can become a “lower” surface simply by turning the object over. Nevertheless, it is still the same surface and the object remains the same. As used herein, “and/or” means “and” or “or”, as well as “and” and “or.” Moreover, all patent and non-patent literature cited herein is hereby incorporated by reference in its entirety for all purposes.

And, those of ordinary skill in the art will appreciate that the exemplary embodiments disclosed herein can be adapted to various configurations and/or uses without departing from the disclosed principles. Applying the principles disclosed herein, it is possible to provide a wide variety of pelletized materials suitable for use in thermochemical storage systems, and related methods and systems to store thermal energy for later use. For example, the principles described above in connection with any particular example can be combined with the principles described in connection with another example described herein. Thus, all structural and functional equivalents to the features and method acts of the various embodiments described throughout the disclosure that are known or later come to be known to those of ordinary skill in the art are intended to be encompassed by the principles described and the features and acts claimed herein. Accordingly, neither the claims nor this detailed description shall be construed in a limiting sense, and following a review of this disclosure, those of ordinary skill in the art will appreciate the wide variety of thermochemical storage systems, and related methods and systems that can be devised using the various concepts described herein. For example, the following paragraphs recite selected combinations of subject matter described herein.

A multiphase pellet comprising a calcium-based material, such as, for example, calcium oxide or calcium carbonate, in combination with an aluminum or silicon containing binder, such as, for example, calcium aluminate cement or alumina, said multiphase pellet suitable for solid-fluid cycling reactions and having sufficient mechanical strength and chemical reactivity to survive over a large number of cycles, e.g., more than 100 cycles, such as, for example, more than 200 cycles, more than 300 cycles, more than 500 cycles, more than 1,000 cycles, or more than 2,000 cycles.

The pellet according to paragraph wherein the calcium-based material comprises a calcium compound such as, for example, lime, limestone and plaster of paris.

The pellet according to paragraph [0065], wherein the calcium-based material forms calcium oxide when heated to an appropriate temperature.

The pellet according to paragraph [0065], wherein the binder comprises an inorganic material.

The pellet according to paragraph wherein the inorganic material comprises aluminum.

The pellet according to paragraph [0069], wherein the aluminum-containing binder comprises a mineral containing alumina, aluminum hydroxide, or both.

The pellet according to paragraph wherein the aluminum containing binder comprises calcium aluminate cement.

The pellet according to paragraph wherein the complex hydrate phase present is C3AH6 and it dehydrates at temperatures above 350° C. to form mayenite as the complex binder in its dehydrated state.

The pellet according to paragraph [0069], wherein the aluminum containing binder, when hydrated in the presence of CaO, forms C3AH6 as a complex hydrate phase.

A multiphase pellet for thermochemical energy storage involving hydration and dehydration of CaO and Ca(OH)₂and the complex binders to tune energy storage at different temperatures.

A method for preparing the pellet comprising pelletizing a mixture of a calcium-based material such as, for example, calcium oxide or calcium carbonate, and a binder such as, for example, calcium aluminate cement or alumina.

The method according to paragraph [0075], wherein the act of pelletizing a mixture of the calcium-based material and the binder comprises:
dry mixing the mixture of calcium-based material and binder; and
wet mixing the mixture of calcium-based material and binder with an amount of water between about 30 and about 100% by weight of the cementitious binder.

The method according to paragraph [0078], wherein the act of pelletizing a mixture of the calcium-based material and the binder comprises forming pellets and curing the pellets so formed at temperatures ranging from room temperature to 60° C. for a period of between 24 hours and 2 months.

A method for regenerating pellets containing calcium-based material and binder.

The method according to paragraph [0078], wherein the act of regenerating pellets comprises crushing the pellets into fine powder having a particle size less than about 50 μm.

The method according to paragraph [78, wherein the act of regenerating pellets comprises pelletizing the fine powder.

A method comprising, using a complex binder in a thermochemical energy storage process through hydration and dehydration of the complex binder.

The method according to paragraph [0081], wherein the act of hydration of the complex binder comprises hydrating the complex binder in an environment having a pH greater than about 12.

The method according to paragraph wherein the environment comprises a presence of CaO/Ca(OH)₂.

A method for using a plurality of pellets formed according to any of the foregoing paragraphs under different temperature conditions.

The method according to paragraph [0084], wherein each pellet among the plurality of pellets comprises a complex binder, the method further comprising dehydration and hydration of the complex binder in each respective pellet.

The method according to paragraph further comprising dehydration of the complex binder hydrate at temperatures of about 350° C.

The method according to paragraph further comprising dehydration and hydration of CaO and Ca(OH)₂.

The method according to paragraph further comprising dehydration of Ca(OH)₂ at a temperature above about 450° C.

The method according to any of paragraphs to [0088], wherein the binder comprises a cementitious binder.

Moreover, nothing disclosed herein is intended to be dedicated to the public regardless of whether such disclosure is explicitly recited in the claims. No claim feature is to be construed under the provisions of 35 USC 112(f), unless the feature is expressly recited using the phrase “means for” or “step for”.

The appended claims are not intended to be limited to the embodiments shown herein but are to be accorded the full scope consistent with the language of the claims, wherein reference to a feature in the singular, such as by use of the article “a” or “an” is not intended to mean “one and only one” unless specifically so stated, but rather “one or more”. Further, in view of the many possible embodiments to which the disclosed principles can be applied, we reserve the right to claim any and all combinations of features and technologies described herein as understood by a person of ordinary skill in the art, including the right to claim, for example, all that comes within the scope and spirit of the foregoing description, as well as the combinations recited, literally and equivalently, in any claims presented anytime throughout prosecution of this application or any application claiming benefit of or priority from this application, and more particularly but not exclusively in the paragraphs appended hereto.

We currently claim:

1. A multiphase pellet comprising a calcium-based material in combination with an aluminum-containing binder or a silicon-containing binder, or both, wherein the multiphase pellet can undergo more than about 100 standard cycles of charging and discharging.

2. The multiphase pellet according to claim 1, wherein the calcium-based material comprises one or more of lime, limestone, plaster-of-paris, calcium oxide and calcium carbonate.

3. The multiphase pellet according to claim 1, wherein the binder comprises one or more of Portland cement, alumina, aluminum hydroxide, an aluminosilicate, calcium aluminate cement, bauxite, and kaolin.

4. The multiphase pellet according to claim 1, wherein the pellet gains at least 95% of a theoretical percentage weight gain of the pellet during hydration after undergoing more than about 100 standard cycles of charging and discharging.

5. The multiphase pellet according to claim 1, wherein the multiphase pellet has a mean characteristic dimension equal to or less than about 6 mm.

6. The multiphase pellet according to claim 5, wherein the multiphase pellet has a mean characteristic dimension equal to or greater than about 1 mm.

7. The multiphase pellet according to claim 1, wherein the multiphase pellet can undergo more than about 1,000 standard cycles of charging and discharging.

8. The multiphase pellet according to claim 1, wherein the weight percentage of binder is at least about 5%.

9. The multiphase pellet according to claim 1, wherein a complex hydrate phase comprises C3AH6 and dehydrates at temperatures between about 330° C. and 350° C. to form mayenite as the binder in the pellet's dehydrated state.

10. The multiphase pellet according to claim 9, wherein the mayenite binder hydrates to C3AH6 on subsequent hydration of the multiphase pellet.

11. The multiphase pellet according to claim 1, wherein the aluminum-containing binder, when hydrated in the presence of CaO/Ca(OH)₂, forms C3AH6 as a complex hydrate phase.

12. A method of storing and releasing thermochemical energy with a pelletized material comprising a calcium-based material in combination with an aluminum-containing binder or a silicon-containing binder, or both, the method comprising:
charging the pelletized material by heating it at a temperature of at least about 350 ° C;
discharging the pelletized material with water, steam, or humidified air, or a combination thereof, to cause the pellets to release heat.

13. The method according to claim 12, wherein an average pellet size of the pelletized material remains above about 0.8 mm after about 100 cycles of charging and discharging the pelletized material.

14. The method according to claim 13, wherein the average pellet size of the pelletized material remains above about 0.8 mm after about 1,000 cycles of charging and discharging the pelletized material.

15. The method according to claim 12, wherein the calcium-based material comprises one or more of lime, limestone, plaster-of-paris, calcium oxide and calcium carbonate.

16. The method according to claim 12, wherein the binder comprises one or more of Portland cement, alumina, aluminum hydroxide, an aluminosilicate, calcium aluminate cement, bauxite, and kaolin.

17. The method according to claim 12, wherein the pelletized material gains at least 95% of a theoretical percentage weight gain of the pelletized material during discharge after undergoing more than about 100 standard cycles of charging and discharging.

18. The method according to claim 12, wherein the pelletized material has a mean characteristic dimension equal to or less than about 6 mm.

19. The method according to claim 18, wherein the pelletized material has a mean characteristic dimension equal to or greater than about 1 mm.

20. The method according to claim 12, wherein the pelletized material comprises C3AH6 after the act of hydrating the pelletized material.

21. The method according to claim 12, wherein the pelletized material comprises mayenite after the act of dehydrating the pelletized material.

22. The method according to claim 21, wherein the mayenite binder hydrates to C3AH6 on subsequent hydration of the pelletized material.

23. The method according to claim 12, further comprising regenerating the pelletized material.

24. The method according to claim 23, wherein the act of regenerating the pelletized material comprises crushing the pellets into fine powder having a particle size less than about 50 μm.

25. The method according to claim 23, wherein the act of regenerating the pelletized material further comprises pelletizing the fine powder into a pelletized form having a mean characteristic dimension equal to or greater than about 1 mm.

26. The method according to claim 25, wherein the pelletized form has a mean characteristic dimension equal to or less than about 6 mm.
